(19) United States
(12) Patent Application Publication
(10) Pub. No.: US 2023/0176261 A1
(43) Pub. Date: Jun. 8, 2023

(54) UNIAXIAL OPTICAL MULTI-MEASUREMENT IMAGING SYSTEM

(71) Applicant: Utah State University Space Dynamics Laboratory, North Logan, UT (US)

(72) Inventor: Aaron Pung, Albuquerque, NM (US)

(73) Assignee: Utah State University Space Dynamics Laboratory, North Logan, UT (US)

(21) Appl. No.: 17/974,094

(22) Filed: Oct. 26, 2022

Related U.S. Application Data
(63) Continuation-in-part of application No. 17/540,327, filed on Dec. 2, 2021.
Application No. 17/540,327 is a continuation of application No. 17/954,446, filed on Sep. 28, 2022.

(51) Int. Cl. G02B 3/00; G02B 5/20; H04N 5/225

(52) U.S. Cl. CPC G02B 3/0068; G02B 5/201; H04N 5/2254

(57) ABSTRACT

A uniaxial optical multi-measurement imaging system includes an imaging lens column having an optical axis and configured to receive light from a scene from a single viewpoint. The imaging system also includes a light redistribution optic (LRO) in the shape of a thin pyramid shell with an apex. The LRO is centered along the optical axis with the apex pointing towards the imaging lens column. The LRO has planar sides with each side angled 45 degrees with respect to the optical axis and configured to reflect and transmit the light. The imaging system also includes a circumferential filter array (CFA) concentrically located around the LRO. The CFA is configured to filter the light reflected from or transmitted through the LRO. The imaging system includes multiple image sensors, each positioned to receive the light reflected from or transmitted through the LRO.

### CROSS-REFERENCE TO RELATED APPLICATIONS

This application is a continuation-in-part to U.S. Non-provisional application Ser. No. 17/540,327, filed on Dec. 2, 2021, and entitled “Uniaxial Optical Multi-Measurement Sensor,” which is incorporated by this reference in its entirety. This application is also a continuation-in-part to U.S. Non-provisional application Ser. No. 17/954,446, filed on Sep. 28, 2022, and entitled “Aperture Stop Exploitation Camera,” which is incorporated by this reference in its entirety.

### BACKGROUND OF THE INVENTION

### Field of the Invention

The present disclosure relates to measuring properties of light from a scene, and more particularly, to novel systems and methods for measuring multiple properties of light from a scene from a single viewpoint.

### Description of Related Art

The complexity of modern camera systems varies widely based on their application. Point-and-shoot, interchangeable-lens, and digital single-lens reflex cameras are typically used for photography and are rarely used to analyze more than one aspect of a scene. In comparison, specialized scientific cameras are often tasked with providing one or more polarimetric, spectral, temporal, or high-dynamic range analyses.

To increase the analysis capabilities of the camera, recent efforts have added optical components such as prisms, compound optics, and beamsplitters to the camera's optical assembly to generate multiple images from the incident scene. Similar to compact multispectral systems, the resulting images can be recombined during post-processing to extract information about materials or objects within the scene.

Since many of these systems rely on splitting the spectral or polarimetric content of the incident light, the resulting set of images does not retain the full content of the original scene. One solution—the snapshot multispectral imager—filters both polarization and wavelength simultaneously, decoupling the polarization and spectral data during post-processing. However, this technique remains limited in the number of usable spectral bands as well as the parallax induced by close-range targets.

### SUMMARY OF THE INVENTION

The inventor of embodiments of the present disclosure has identified an alternative approach to form multiple images within a uniaxial optical multi-measurement imaging system, such that each image retains all spectral and polarimetric content. By retaining this information, each image can be independently captured, filtered, processed, and analyzed.

In embodiments, a uniaxial optical multi-measurement imaging system includes an imaging lens column having an optical axis. The imaging lens column is configured to receive and transmit light from a scene from a single viewpoint. The imaging system also includes a light redistribution optic (LRO) in the shape of a thin pyramid shell with an apex. The LRO is centered along the optical axis with the apex pointing towards the imaging lens column. The LRO has planar sides with each side angled 45 degrees with respect to the optical axis and each side is configured to reflect and transmit light received from the imaging lens column. The imaging system also includes a circumferential filter array (CFA) concentrically located around the LRO. The CFA is configured to filter the light reflected from or transmitted through the LRO. Finally, the imaging system includes multiple image sensors. Each image sensor is positioned to receive the light reflected from or transmitted through the LRO.

In general, this approach is similar to the previous multispectral imaging systems described in the inventor's previous disclosures in that it utilizes additional components placed along the optical axis to split the incident light field. Unlike other systems, however, the LRO does not rely on spectral or polarimetric splitting; instead, in embodiments, a simple broadband 50/50 reflection coating may be applied to the forward-facing surfaces of the LRO. In turn, the customizable CFA is able to filter each reflected image independently, greatly increasing the analysis capabilities and versatility of the imaging system.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is an embodiment of a uniaxial multi-measurement imaging system;

FIG. 2 is another embodiment of a uniaxial multi-measurement imaging system;

FIG. 3 is another embodiment of a uniaxial multi-measurement imaging system;

FIG. 4 is a CAD rendering of an embodiment of a uniaxial multi-measurement imaging system;

FIG. 5 is an embodiment of a circumferential filter array (CFA);

FIGS. 6A, 6B, and 6C are example filters that may be applied to a CFA;

FIG. 7A is an example input image; FIG. 7B is the transmitted image of FIG. 7A;

FIGS. 7C, 7D, 7E, and 7F are the reflected images of FIG. 7A; and FIG. 7G is a composite image of each reflected image (shown in FIGS. 7C-7F); and

FIG. 8 is an example process of capturing an image of a scene from a uniaxial multi-measurement imaging system.

### DETAILED DESCRIPTION

The present disclosure covers apparatuses and associated methods for a uniaxial optical multi-measurement imaging system. In the following description, numerous specific details are provided for a thorough understanding of specific preferred embodiments. However, those skilled in the art will recognize that embodiments can be practiced without one or more of the specific details, or with other methods, components, materials, etc. In some cases, well-known structures, materials, or operations are not shown or described in detail to avoid obscuring aspects of the preferred embodiments. Furthermore, the described features, structures, or characteristics may be combined in any suitable manner in a variety of alternative embodiments. Thus, the following more detailed description of the embodiments of the present invention, as illustrated in some aspects in the drawings, is not intended to limit the scope of the invention, but is merely representative of the various embodiments of the invention.

In this specification and the claims that follow, singular forms such as “a,” “an,” and “the” include plural forms unless the content clearly dictates otherwise. All ranges disclosed herein include, unless specifically indicated, all endpoints and intermediate values. In addition, “optional”, “optionally” or “or” refer, for example, to instances in which subsequently described circumstance may or may not occur, and include instances in which the circumstance occurs and instances in which the circumstance does not occur. For example, if the text reads “option A or option B,” there may be instances where option A and option B are mutually exclusive or instances where both option A and option B may be included. The terms “one or more” and “at least one” refer, for example, to instances in which one of the subsequently described circumstances occurs, and to instances in which more than one of the subsequently described circumstances occurs.

The following examples are illustrative only and are not intended to limit the disclosure in any way.

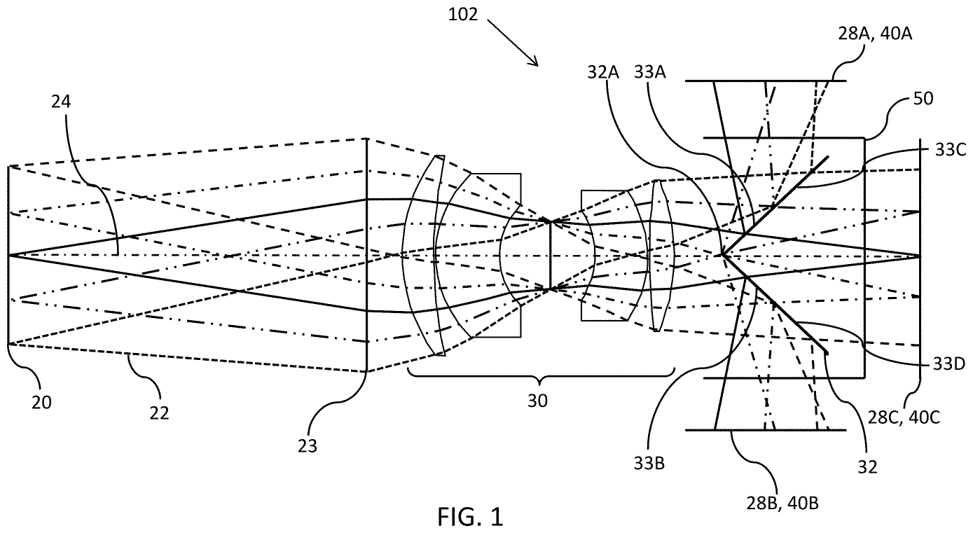

FIG. 1 illustrates an embodiment of a uniaxial optical multi-measurement imaging system 102 that includes an imaging lens column 30 having an optical axis 24. The imaging lens column 30 is configured to receive and transmit light 22 (shown as a light ray trace) from a scene 20 from a single viewpoint. The imaging system 102 also includes a light redistribution optic (LRO) 32 in the shape of a thin pyramid shell with an apex 32A. The pyramid-shape of the LRO 32 is centered along the optical axis 24 with the apex 32A pointing towards the imaging lens column 30. The LRO 32 has planar sides 33A and 33B with each side (33A and 33B) angled 45 degrees with respect to the optical axis 24 and each side (33A and 33B) is configured to reflect and transmit the light 22 transmitted from the imaging lens column 30. The imaging system 102 also includes a circumferential filter array (CFA) 50 concentrically located around the LRO 32. The CFA 50 is configured to filter the light 22 reflected from or transmitted through the LRO 32.

In FIG. 1, light, illustrated as light ray traces 22, from a scene 20, enters the imaging system 102. Note that the light ray traces include the various dashed lines emanating from the scene 20. In addition, the light or light ray traces 22 pass through a paraxial lens 23, which is a surface that acts like an ideal thin lens, configured such that light 22 from any point in the scene 20 would pass through the paraxial lens 23 and come together at a single point in the image (e.g., images 28A, 28B, or 28C), devoid of any aberrations.

In this example of the uniaxial optical multi-measurement imaging system 102, the LRO 32 has two planar sides 33A and 33B facing the imaging lens column 30. A first planar side 33A of the LRO 32 is configured to reflect the light 22 transmitted from the imaging lens column 30 to a first image sensor 40A. A second planar side 33B of the LRO 32 is configured to reflect the light 22 transmitted from the imaging lens column 30 to a second image sensor 40B. Also, both first 33A and second 33B planar sides of the LRO 32 are configured to transmit light 22 from the imaging lens column 30 to a third image sensor 40C. First 28A, second 28B, and third 28C independent, spatially separate images from the scene 20 may be captured by the multiple image sensors 40A, 40B, and 40C.

Design of the LRO 32 was based on the convergence of light rays 22 leaving the lens column 30 and the optical path length of light traveling between the lens column 30 and the on-axis detector 40C. In conventional imaging systems, light rays exiting the lens column horizontally and vertically converge to form a focused image on the detector. To continue the convergence in a uniaxial system, each forward-facing surface 33A, 33B, of the LRO 32 is planar. Additionally, on-axis rays will travel a shorter distance from the lens column 30 to the detector 40C compared to off-axis rays. Geometrically, this indicates the LRO 32 should be angled along the optical axis with the apex 32A placed closest to the lens column 30.

To satisfy these conditions, the LRO 32 was modeled as a thin pyramidal shell of Schott FK3 glass. The faces of the pyramid are angled at 45 degrees with respect to the optical axis 24, the base of the pyramid (LRO 32) is square, and the apex 32A of the pyramid lies along the optical axis 24 pointed towards the lens column 30. To work with existing camera hardware, the diagonal of the pyramid's base may be designed to be shorter than the diameter of the largest lens in the column 30. The design of the LRO 32 is advantageous in that it is lightweight, modular, intuitive to design, and does not complicate ray tracing through the imaging system 102. However, the size, position, and geometry of the LRO 32 must be carefully chosen since each parameter directly impacts image quality.

Changing the slope of the LRO surfaces 33A and 33B, for instance, induces a tilt on the plane aligning the focal points of the optical rays. For this reason, decreasing the depth of pyramidal shell along the optical axis 24 while keeping its width and height the same results in a set of blurry, stretched images 28A and 28B on the circumferential detectors 40A and 40B. This change also results in a lateral shift of the images due to the change in the angle of incidence between the rays leaving the lens column 30 and the LRO surfaces 33A and 33B. Finally, the forward-facing surfaces 33A and 33B of the LRO 32 must be kept flat; while conical and other non-planar surfaces may allow light to converge along one axis, they also cause light to reflect divergently along the other axis, again leading to blurry images.

In embodiments, the surfaces 33A and 33B on the front (lens-facing) side of the LRO 32 may be coated with a broadband 50/50 reflective coating to equally divide light from the lens column into a reflected (28A and 28B) and transmitted (28C) image. Similarly, the back side (33C and 33D) of the LRO 32 may be coated with a broadband anti-reflection (AR) coating to reduce internal reflections. Since light rays exiting the lens column 30 strike the LRO 32 at different angles, both coatings must be insensitive to angle of incidence (AoI) and wavelength. Fortunately, optical coatings that satisfy these requirements are well known and are commercially available. For example, the optical coating used on Thorlabs' BSW16 50:50 Plate Beamsplitter provides 50% transmission at 45-degree AoI across the visible regime and exhibits less than 10% variation in transmittance at AoI values as large as 30 degrees from the surface normal.

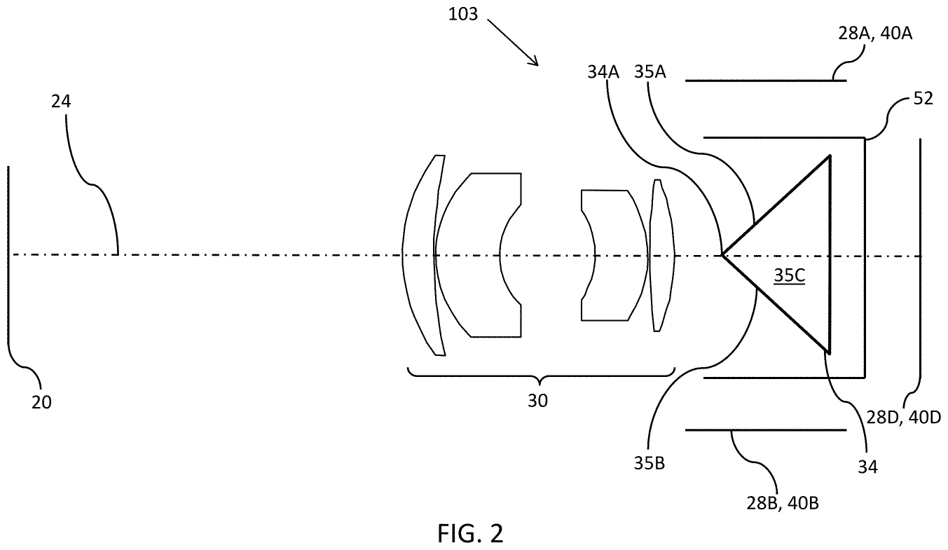

FIG. 2 illustrates another embodiment of a uniaxial optical multi-measurement imaging system 103. In FIG. 2, the ray traces of light have been removed for clarity. In embodiments, a uniaxial optical multi-measurement imaging system 103 includes an LRO 34 with three planar sides 35A, 35B, and 35C facing the imaging lens column 30. The imaging system 103 also includes a circumferential filter array (CFA) 52 concentrically located around the LRO 34. The CFA 52 is configured to filter the light reflected from or transmitted through the LRO 34.

A first planar side 35A of the LRO 34 is configured to reflect the light transmitted from the imaging lens column 30 to a first image sensor 40A. A second planar side 35B of the LRO 34 is configured to reflect the light transmitted from the imaging lens column 30 to a second image sensor 40B. A third planar side 35C of the LRO 34 is configured to reflect the light transmitted from the imaging lens column 30 to a third image sensor (not labeled in FIG. 2 as third image sensor is positioned out of the page view). The first 35A, second 35B, and third 35C planar sides of the LRO 34 are configured to transmit light from the imaging lens column 30 to a fourth image sensor 40D. First 28A, second 28B, third (not labeled), and fourth 28D independent, spatially separate images from the scene 20 may be captured by first image sensor 40A, second image sensor 40B, third image sensor (not labeled in FIG. 2) and fourth image sensor 40D, respectively.

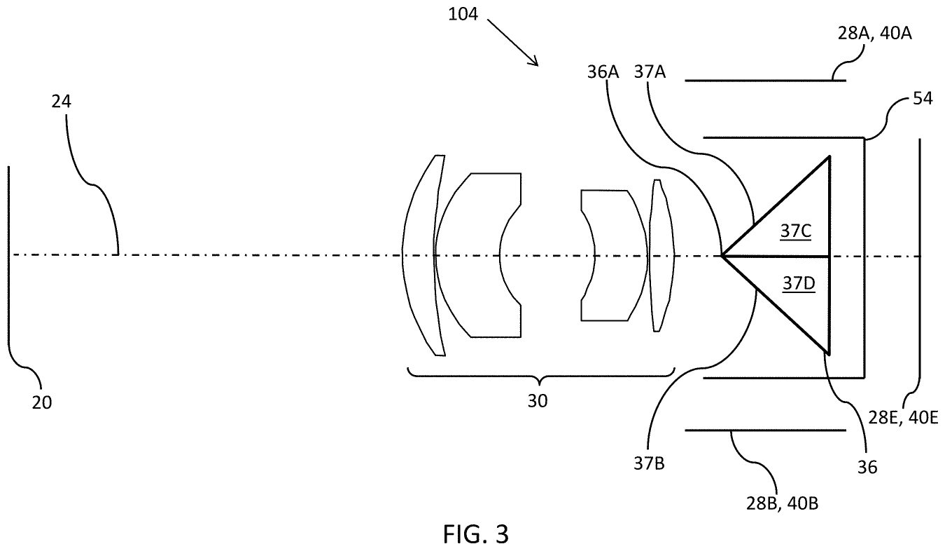

FIG. 3 illustrates another embodiment of a uniaxial optical multi-measurement imaging system 104. In FIG. 3, the ray traces of light have been removed for clarity. In embodiments, a uniaxial optical multi-measurement imaging system 104 includes an LRO 36 with four planar sides 37A, 37B, 37C, and 37D facing the imaging lens column 30. The imaging system 104 also includes a CFA 54 concentrically located around the LRO 36. The CFA 54 is configured to filter the light reflected from or transmitted through the LRO 36.

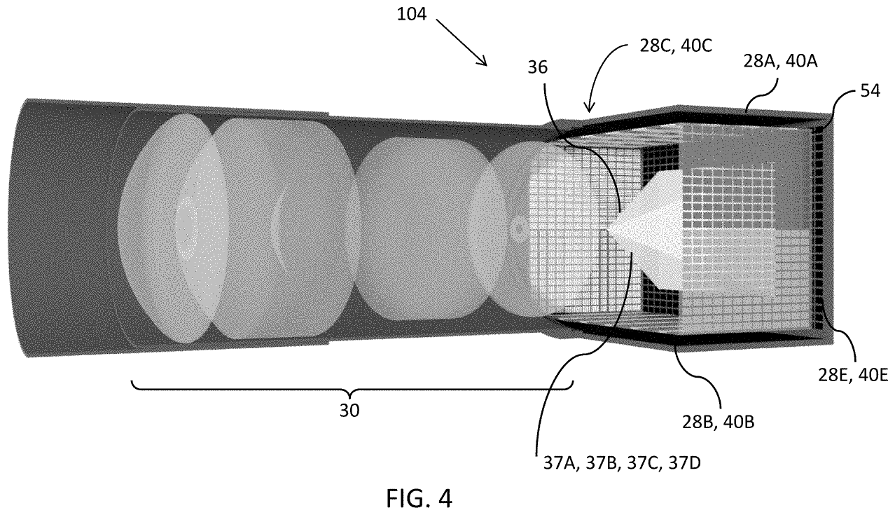

A first planar side 37A of the LRO 36 is configured to reflect the light transmitted from the imaging lens column 30 to a first image sensor 40A. A second planar side 37B of the LRO 36 is configured to reflect the light transmitted from the imaging lens column 30 to a second image sensor 40B. A third planar side 37C of the LRO 36 is configured to reflect the light transmitted from the imaging lens column 30 to a third image sensor (not labeled in FIG. 3). A fourth planar side 37D of the LRO 36 is configured to reflect the light transmitted from the imaging lens column 30 to a fourth image sensor (not labeled in FIG. 3). The third and fourth image sensors, which would be labeled 40C and 40D, are not illustrated in the FIG. 3 viewpoint but would be shown in an isometric view, similar to the isometric view in FIG. 4. The first 37A, second 37B, third 37C, and fourth 37D planar sides of the LRO 36 are configured to transmit light from the imaging lens column 30 to a fifth image sensor 40E. First 28A, second 28B, third (not labeled in FIG. 3), fourth (not labeled in FIG. 3), and fifth 28E independent, spatially separate images from the scene 20 may be captured by first image sensor 40A, second image sensor 40B, third image sensor (not labeled in FIG. 3), fourth image sensor (not labeled in FIG. 3), and fifth image sensor 40E, respectively.

Unsurprisingly, the shape of the LRO 36 greatly influences the size and shape of the reflected images 28A, 28B, 28C (not labeled in FIG. 3), and 28D (also not labeled in FIG. 3). The faces 37A, 37B, 37C, and 37D of the LRO 36 for example, can impose a triangular shape on the reflected images 28A-28D, and the portion of the incident field represented by each reflected image 28A-28D depends on the size and position of the LRO 36. When placed along the optical axis 24 of the imaging system 104, the apex of each triangular reflection will be located at the center of the field exiting the lens column 30. Furthermore, the shape of the base of the LRO 36 determines how much of the incident scene is captured. Due to the shape mismatch between the rectangular sensor and the square pyramid base, the width of the LRO 36 can be made to match either the width or height of the sensor. If the height of the sensor is matched, the LRO 36 may not fully reflect the left- and right-most edges of the original scene. The only function of the LRO 36 is to redirect light (not shown or labeled in FIG. 3) exiting the lens column 30 without compromising its convergence. Therefore, adjustments to the lens column 30 (ex. focus and zoom) will be directly imposed on the reflected (28A-28D) and transmitted (28E) images. Furthermore, a significant portion of the space between the lens column 30 and the detector 40E is now taken up by the LRO 36, resulting in additional limitations on the f-number (f/#) of the system 104. In turn, this also impacts aperture vignetting across all five images (28A, 28B, 28C, 28D, and 28E).

FIG. 4 illustrates a three-dimensional cut-away CAD rendering of uniaxial multi-measurement imaging system 104 also illustrated in FIG. 3. The third and fourth image sensors are not shown because FIG. 4 illustrates a cut-away rendering (that does not show the third image sensor) and the fourth image sensor is obscured by the CFA 54.

In embodiments, each image sensor measures or images a different property of the light 22 from the scene 22 from the single viewpoint.

Also in embodiments, the light 22 entering the imaging lens column 30 is uncollimated and the imaging lens column 30 is configured to receive the uncollimated light 22 and direct the uncollimated light 22 onto and through the LRO 32, 34, or 36.

Also in embodiments, the planar sides (e.g., planar sides 33A, 33B, or 35A, 35B, 35C, or 37A, 37B, 37C, 37D) of LROs 32, 34, or 36, are angled 45 degrees with respect to the optical axis 24 and are coated with a reflective coating (not illustrated) configured to divide the light 22 transmitted from the imaging lens column 30 into reflected images (e.g., images 28A, 28B, 28C (not illustrated), and 28D (not illustrated) from system 104) and a transmitted images 28C (from system 102), 28D (from system 103) or 28E (from system 104).

Similarly, the planar sides (e.g., planar sides 33A, 33B, or 35A, 35B, 35C, or 37A, 37B, 37C, 37D) of LROs 32, 34, or 36, are angled 45 degrees with respect to the optical axis and are coated with a broadband 66% reflective coating (not shown) configured to equally divide the light transmitted from the imaging lens column 30 into reflected (e.g., images 28A, 28B, 28C (not illustrated), and 28D (not illustrated) from system 104) and transmitted images 28C (from system 102), 28D (from system 103) or 28E (from system 104).

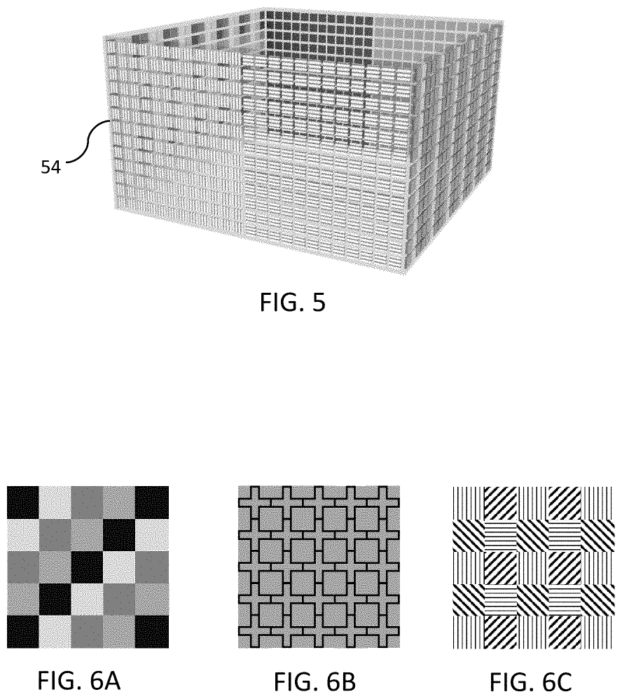

FIG. 5 illustrates an example CFA 54. In embodiments, the CFA is concentrically located around the LRO 32, 34, or 36 and has a corresponding number of faces to filter the light reflected from or transmitted through the LRO 32, 34, or 36. FIGS. 6A, 6B, and 6C are examples of different filters that may be applied to different surfaces of CFA 50, 52, or 54.

The CFA 54 is modeled as an optically transparent substrate whose surfaces are coated with spectral, polarimetric, or neutral density filters (FIG. 6A, 6B, or 6C), or combinations thereof. In practice, the ideal substrate would be lightweight, amenable to state-of-the-art thin film optical filter fabrication techniques, and mounted within the system 102, 103, or 104 as a removable component.

In doing so, the CFA 54 can be customized for the application at hand or exchanged for a different filter array suited for the same adapter. For multispectral applications, the generic filters described above could be extracted and replaced with another CFA containing spectral, plasmonic, or polarimetric filter geometries.

In this respect, the CFA 54 is similar to the polarized-type divided aperture color-coding (P-DACC) unit used in the snapshot multispectral imager (SMI) system: both are modular, both are designed to be swapped without changing other camera components, and both are meant to provide spectral and polarimetric data about a scene.

One of the key differences between the two approaches is the position of the filter. In the SMI system, the P-DACC unit is placed as an aperture stop within the lens column. Not only does this limit the spatial footprint available for designing and placing filters, but it also limits the number of spectral bands that can be imaged by the color polarization image (CPI) sensor. In this configuration, only nine spectral bands are available for subsequent image analysis. A similar approach could be used with the uniaxial geometry by placing the color polarization filters on the CFA 54 and using CPI sensors for the circumferential detectors.

In turn, the LRO 36 (in FIG. 3) distributes the incident field amongst four CPI detectors 40A, 40B, 40C (not shown), and 40D (not shown); even though the total detected area of the filtered images remains the same, the number of usable spectral bands is quadrupled, leading to greater versatility in multispectral index calculations.

Referring back to FIG. 3, removing the filter array, e.g., CFA 54 from the optical axis 24 of the camera 104 ensures the uniaxial imaging system 104 always captures one unfiltered image on the back-side detector 40E. During post processing, the transmitted image 28E acts as a reference for each of the filtered images 28A, 28B, 28C, and 28D, enabling the system to extract information not filtered by the CFA 54. For example, if the CFA 54 contained linear polarization filters rotated at 0, 45, and 90 degrees, the transmitted (reference) image 28E could be used to extract arbitrary polarization angle information of the scene 20. Once the Stokes parameters are calculated, additional polarization metrics such as the Degree of Linear Polarization (DoLP) and Angle of Linear Polarization (AoLP) can be found. For this reason, although it is possible to apply a filter coating to the front (e.g., 37A, 37B, 37C, and 37D) and back surfaces (not labeled) of the LRO 36, doing so is not preferred since it would negate the possibility of using the transmitted image 28E as a reference.

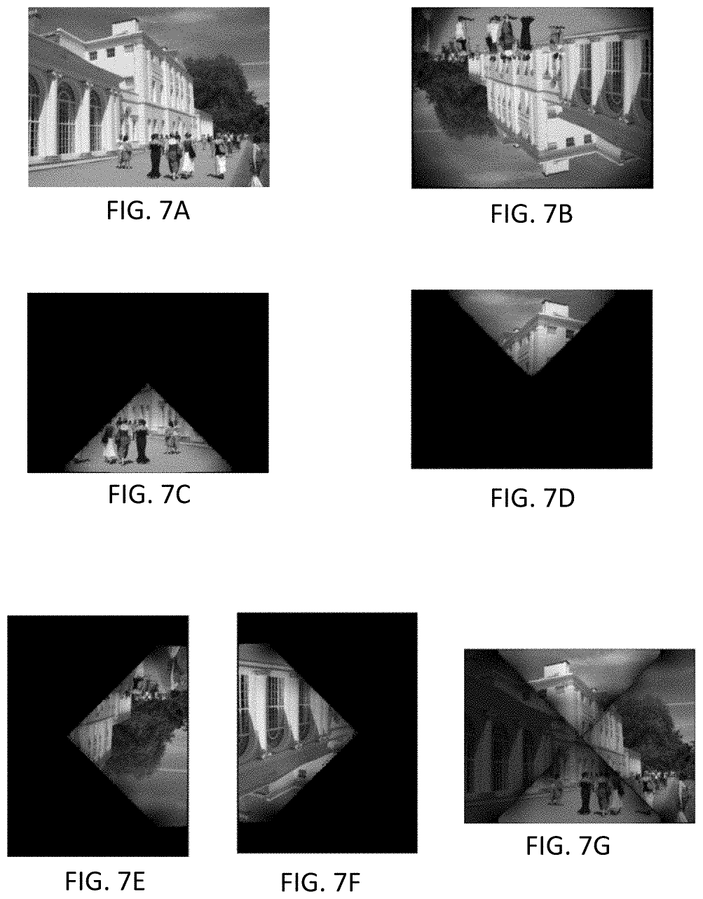

FIG. 7A is an example input image. The content of the image is not important to understand embodiments of the present invention, only that it is an image. FIG. 7B is the transmitted image of FIG. 7A that may be captured by sensor 40C in system 102, sensor 40D in system 103, or sensor 40E in system 104.

FIGS. 7C, 7D, 7E, and 7F are the reflected images of FIG. 7A as they would be captured by sensors 40A, 40B, 40C (not shown), and 40D (not shown) in system 104. FIG. 7G is a composite image of each reflected image (shown in FIGS. 7C-7F).

To simplify the explanation of the images illustrated in FIGS. 7B-7F, the CFA 54 is modeled as an optically transparent film without filters of any kind. The input image in FIG. 7A enters the imaging system 104 and exits the lens column 30 as a vertically and horizontally flipped version of the original. Validation of the transmitted field (FIG. 7B) is straight-forward since it resembles the field exiting the lens column 30.

Similarly, each reflected image (7C, 7D, 7E, and 7F) can be intuitively validated by examining the ray trace in FIG. 1. For example, the bottom most rays of the input image (FIG. 7A) or the scene 20 in FIG. 1 propagate through the lens column 30 and are reflected towards the top-most sensor 40A by the widest portion of the LRO's top surface (37A in FIG. 3). The reflection from the LRO 36 causes the field to vertically flip again before striking the sensor 40A. Therefore, the top-most sensor 40A should show the bottom portion of the input image or scene 20, defined by a triangular region with its apex located at the center of the input image (e.g., an input image as illustrated in FIG. 7A). The image should be upright, but should share the same lateral flip as the transmitted image. This precisely matches the simulated image in FIG. 7C. Similar logic can be applied to the image collected by the bottom-most sensor 40B (the image illustrated in FIG. 7D).

Validation of the right and left images also follows similar reasoning. Rays from the right side of the input image (e.g., scene 20) propagate through the lens column 30 and are reflected towards the left-most sensor 40C by the widest portion of the LRO's left surface 37C. During the reflection, the image retains is upside down orientation, but is flipped again laterally before striking the left-most sensor 40C. Therefore, the left-most image (shown in FIG. 7E) should show the right portion of the input image, defined by a triangular region with its apex located at the center of the input image. An object on the far-right side of the input image (FIG. 7A) should still be on the right-hand side, but should share the same vertical flip as the transmitted image (FIG. 7B). This matches the simulated image in FIG. 7E. Applying similar logic to the image collected by the right-most sensor 40D yields FIG. 7F. Lastly, FIG. 7G illustrates a composite image of the four reflected images (7C, 7D, 7E, and 7F), each using a different optical filter. For example, the left, bottom, and right images may use a 25% transmission neutral density filter, a red-pass filter, and a red- and green-pass filter, respectively. Also, the top portion may be left unfiltered as a reference.

A uniaxial imaging system described in this work was numerically validated in Zemax OpticStudio using commercially available materials and lenses. Lens parameters are the same as those defined in OpticStudio's “Double Gauss Experimental Arrangement” example. Although each detector within the simulation is modeled as identical color sensors utilizing a Bayer pixel pattern, this does not have to be the case since multispectral image analysis can be performed using highly scattering filters and monochrome sensors.

One notable difference between simulations and a physical system is the requirement of the software to trace a chief ray from the input image or scene 20 to the detectors (e.g., detectors 40A-40E in FIG. 3). Based on the geometry of an LRO (e.g., LRO 36), a chief ray traveling along the optical axis 24 will encounter the single point discontinuity at the apex 36A of the pyramid-shaped LRO 36. To satisfy requirements of the numerical model, the LRO 36 was displaced 0.1 mm in the direction opposite a circumferential detector to enable continuity of the chief ray. In a physical system, however, the apex and corners of the LRO would likely create discontinuities in the reconstructed image based on the scattering of the incident light.

Nonetheless, embodiments of the proposed imaging system provide many advantages over existing multispectral cameras. First and foremost, the addition of an LRO and CFA to the base imaging system only increase its functionality and capability. Since both components are designed to be modular and removable, they can be taken out of the optical assembly and original functionality is restored. Additionally, an LRO splits the incident image or scene 20 in a way that both enables each (reflected) sub-image to be filtered and processed independently, and keeps the original (transmitted) image unfiltered to be used as a reference during post-processing—capabilities that do not exist in systems that rely on splitting the scene's spectral and polarimetric content.

Similarly, a CFA introduces a fresh approach to filtering data within the camera system. The high degree of customization offered by a CFA is based on its circumferential design; not only can the filters be chosen and arranged based on the application, but the filters themselves can be tailored to fit the incident light source and detector geometries. Furthermore, the ability to independently apply custom filters to different portions of the image greatly extends the versatility of the imaging system. Together, an LRO and CFA offer an intuitive, updated method to split and analyze multiple aspects of the input scene.

Implementing the LRO and CFA within an existing imaging system, though, is not without cost since the hardware and software infrastructure of the camera will need to be modified to accommodate the new components. In addition to the hardware needed to mount the LRO and CFA within a camera housing, four additional image sensors are needed to capture the reflected images, placing a heavier burden on the power and weight of the camera. In turn, each of these changes must be supported by the camera's software. Each of the five sensors, for example, may require its own ISO rating, shutter speed, and aperture setting, so a fixed aperture shared across five sensors may not be ideal. Additionally, each sensor would require pre-processing (demosaicing) to convert its discrete pixel values into a coherent image. Once converted, the raw image data needs to be converted into a useful image format (ex. PNG or JPEG) before being stitched together to form a single reflected image. Furthermore, the cost of the additional sensors may not outweigh the information they gather. Since each circumferential sensor only receives a partial reflection of the incident field, each of these sensors is drastically underfilled. The additional hardware, software, and development of fabrication techniques for the LRO and CFA filters is expected to greatly increase the cost of the camera.

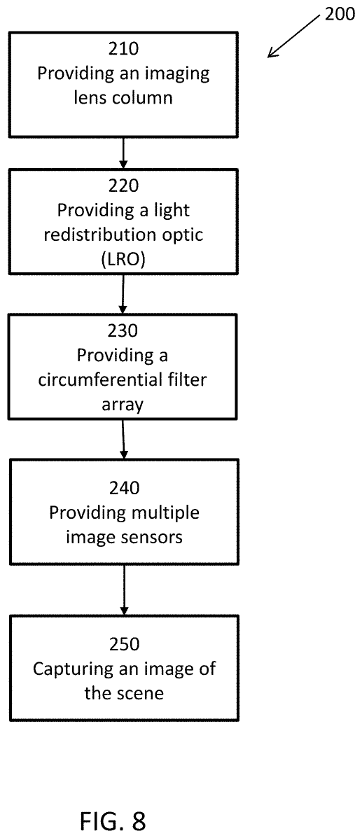

FIG. 8 illustrates an example method 200 of capturing an image of a scene according to embodiments of the present disclosure. In one embodiment, the method comprises providing 210 an imaging lens column having an optical axis and configured to receive and transmit light from a scene from a single viewpoint. The method further comprises providing 220 a light redistribution optic (LRO) in the shape of a thin pyramid shell with an apex. The LRO is centered along the optical axis with the apex pointing towards the imaging lens column. Also, the LRO has planar sides with each side angled 45 degrees with respect to the optical axis and each side configured to reflect and transmit the light transmitted from the imaging lens column.

The method further comprises providing 230 a circumferential filter array concentrically located around the LRO. The filter array is configured to filter the light reflected from or transmitted through the LRO.

Also, the method further comprises providing 240 multiple image sensors.

Finally, the method comprises capturing 250 an image of the scene from each of the multiple image sensors.

The present invention may be embodied in other specific forms without departing from its spirit or essential characteristics. The described embodiments are to be considered in all respects only as illustrative, and not restrictive. All changes which come within the meaning and range of equivalency of the foregoing description are to be embraced within the scope of the invention.

It will be appreciated that several of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art and are also intended to be encompassed by the following claims.

I claim:

1. A uniaxial optical multi-measurement imaging system, comprising:
an imaging lens column having an optical axis and configured to receive and transmit light from a scene from a single viewpoint,
a light redistribution optic (LRO) in the shape of a thin pyramid shell with an apex, the LRO centered along the optical axis with the apex pointing towards the imaging lens column, the LRO having planar sides with each side angled 45 degrees with respect to the optical axis and each side configured to reflect and transmit the light transmitted from the imaging lens column;
a circumferential filter array (CFA) concentrically located around the LRO, the filter array configured to filter the light reflected from or transmitted through the LRO; and
multiple image sensors, each image sensor positioned to receive the light reflected from or transmitted through the LRO.

2. The uniaxial optical multi-measurement imaging system of claim 1, wherein the LRO has two planar sides facing the imaging lens column:
a first planar side of the LRO is configured to reflect the light transmitted from the imaging lens column to a first image sensor;
a second planar side of the LRO is configured to reflect the light transmitted from the imaging lens column to a second image sensor; and
both first and second planar sides of the LRO are configured to transmit light from the imaging lens column to a third image sensor.

3. The uniaxial optical multi-measurement imaging system of claim 1, wherein the LRO has three planar sides facing the imaging lens column:
a first planar side of the LRO is configured to reflect the light transmitted from the imaging lens column to a first image sensor;
a second planar side of the LRO is configured to reflect the light transmitted from the imaging lens column to a second image sensor;
a third planar side of the LRO is configured to reflect the light transmitted from the imaging lens column to a third image sensor; and
the first, second, and third planar sides of the LRO are configured to transmit light from the imaging lens column to a fourth image sensor.

4. The uniaxial optical multi-measurement imaging system of claim 1, wherein the LRO has four planar sides facing the imaging lens column:
a first planar side of the LRO is configured to reflect the light transmitted from the imaging lens column to a first image sensor;
a second planar side of the LRO is configured to reflect the light transmitted from the imaging lens column to a second image sensor;
a third planar side of the LRO is configured to reflect the light transmitted from the imaging lens column to a third image sensor;
a fourth planar side of the LRO is configured to reflect the light transmitted from the imaging lens column to a fourth image sensor; and
the first, second, third, and fourth planar sides of the LRO are configured to transmit light from the imaging lens column to a fifth image sensor.

5. The uniaxial optical multi-measurement imaging system of claim 4, wherein each image sensor measures or images a different property of the light from the scene from the single viewpoint.

6. The uniaxial optical multi-measurement imaging system of claim 1, wherein the light entering the imaging lens column is uncollimated and the imaging lens column is configured to receive the uncollimated light and direct the uncollimated light onto and through the LRO.

7. The uniaxial optical multi-measurement imaging system of claim 1, wherein the CFA has one or more individual filter elements, each filter element having one or more filters.

8. The uniaxial optical multi-measurement imaging system of claim 1, wherein the planar sides angled 45 degrees with respect to the optical axis are coated with a reflective coating configured to divide the light transmitted from the imaging lens column into reflected images and a transmitted image.

9. The uniaxial optical multi-measurement imaging system of claim 1, wherein the planar sides angled 45 degrees with respect to the optical axis are coated with a broadband 66% reflective coating configured to equally divide the light transmitted from the imaging lens column into two reflected images and a transmitted image.

10. A method for measuring light properties, the method comprising:
providing an imaging lens column having an optical axis and configured to receive and transmit light from a scene from a single viewpoint,
providing a light redistribution optic (LRO) in the shape of a thin pyramid shell with an apex, the LRO centered along the optical axis with the apex pointing towards the imaging lens column, the LRO having planar sides with each side angled 45 degrees with respect to the optical axis and each side configured to reflect and transmit the light transmitted from the imaging lens column;
providing a circumferential filter array (CFA) concentrically located around the LRO, the filter array configured to filter the light reflected from or transmitted through the LRO;
providing multiple image sensors, each image sensor positioned to receive the light reflected from or transmitted through the LRO; and
capturing an image of the scene from each of the multiple image sensors.

11. The method of claim 10, wherein:
the LRO has two planar sides facing the imaging lens column:
a first planar side of the LRO is configured to reflect the light transmitted from the imaging lens column to a first image sensor;
a second planar side of the LRO is configured to reflect the light transmitted from the imaging lens column to a second image sensor; and
both first and second planar sides of the LRO are configured to transmit light from the imaging lens column to a third image sensor.

12. The method of claim 10, wherein:
the LRO has three planar sides facing the imaging lens column:
a first planar side of the LRO is configured to reflect the light transmitted from the imaging lens column to a first image sensor;
a second planar side of the LRO is configured to reflect the light transmitted from the imaging lens column to a second image sensor;
a third planar side of the LRO is configured to reflect the light transmitted from the imaging lens column to a third image sensor; and
the first, second, and third planar sides of the LRO are configured to transmit light from the imaging lens column to a fourth image sensor.

13. The method of claim 10, wherein:
the LRO has four planar sides facing the imaging lens column:
a first planar side of the LRO is configured to reflect the light transmitted from the imaging lens column to a first image sensor;
a second planar side of the LRO is configured to reflect the light transmitted from the imaging lens column to a second image sensor;
a third planar side of the LRO is configured to reflect the light transmitted from the imaging lens column to a third image sensor;
a fourth planar side of the LRO is configured to reflect the light transmitted from the imaging lens column to a fourth image sensor; and
the first, second, third, and fourth planar sides of the LRO are configured to transmit light from the imaging lens column to a fifth image sensor.

14. The method of claim 13, wherein each image sensor measures or images a different property of the light from the scene from the single viewpoint.

15. The method of claim 10, wherein the light entering the imaging lens column is uncollimated and the imaging lens column is configured to receive the uncollimated light and direct the uncollimated light onto and through the LRO.

16. The method of claim 10, wherein the CFA has one or more individual filter elements, each filter element having one or more filters.

17. The method of claim 10, wherein the planar sides angled 45 degrees with respect to the optical axis are coated with a reflective coating configured to divide the light transmitted from the imaging lens column into reflected images and a transmitted image.

18. The method of claim 10, wherein the planar sides angled 45 degrees with respect to the optical axis are coated with a broadband 66% reflective coating configured to equally divide the light transmitted from the imaging lens column into two reflected images and a transmitted image.

19. A uniaxial optical multi-measurement imaging system, comprising:
an imaging lens column having an optical axis and configured to receive and transmit light from a scene from a single viewpoint; and
a light redistribution optic (LRO) in the shape of a thin pyramid shell with an apex, the LRO centered along the optical axis with the apex of the thin pyramid shell pointing towards the imaging lens column, the LRO:
having four planar sides with each side angled 45 degrees with respect to the optical axis and each side facing the imaging lens column and configured to reflect and transmit the light transmitted from the imaging lens column:
a first planar side is configured to reflect the light transmitted from the imaging lens column to a first image sensor;
a second planar side is configured to reflect the light transmitted from the imaging lens column to a second image sensor;
a third planar side is configured to reflect the light transmitted from the imaging lens column to a third image sensor;
a fourth planar side is configured to reflect the light transmitted from the imaging lens column to a fourth image sensor; and
all four planar sides are configured to transmit light from the imaging lens column to a fifth image sensor; wherein
each image sensor measures or images a different property of the light from the scene from the single viewpoint.
